(19) United States
(12) Patent Application Publication
(10) Pub. No.: US 2008/0189274 A1
(43) Pub. Date: Aug. 7, 2008

(54) SYSTEMS AND METHODS FOR CONNECTING RELEVANT WEB-BASED PRODUCT INFORMATION WITH RELEVANT NETWORK CONVERSATIONS

(75) Inventor: Aaron Mann, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: 8Lives Technology, Berkeley, CA (US)

(21) Appl. No.: 12/026,359

(22) Filed: Feb. 5, 2008

Related U.S. Application Data
(60) Provisional application No. 60/888,275, filed on Feb. 5, 2007.

(51) Int. Cl. G06F 17/30

(52) U.S. Cl. 707/5; 707/E17.074

(57) ABSTRACT

Search systems and methods for connecting users with relevant information about products or services in which they are interested. Relevant information provided to the users includes links to web pages where the product or service is available and links to discussion groups or other social networking communities where the product or service is being discussed and reporting on the frequency of specific brand and product discussions along with sentiment attributes. Embodiments of the present invention advantageously provide an efficient way to provide or connect consumers with relevant information and web-based conversations about products or services in which they are interested, without the consumer having to actively search multiple disparate websites in the hopes of finding relevant information and conversations. Once connected, users are able to dig deeper for additional information, such as by reviewing and/or joining a conversation or accessing additional sites presented by the system. Business users receive reporting and metrics quantifying the conversations about their brands, products and competitors.

### CROSS-REFERENCES TO RELATED APPLICATIONS

This application claims the benefit of U.S. Provisional Application Ser. No. 60/888,275, (Attorney docket No. 026696-000100US), filed Feb. 5, 2007, the disclosure of which is incorporated herein by reference in its entirety.

### BACKGROUND OF THE INVENTION

The present invention relates generally to Internet search systems, and more particularly to systems and methods for connecting users with relevant web-based product information and relevant network conversations.

In today's web-based society, information is readily available over the Internet. For consumers, this has proven to be very beneficial as product information has become more readily available, especially due to the proliferation of vendor websites and review sites. The need for obtaining product information traditionally been served by vendor sites for those seeking basic information on products and by standard review sites such CNET, Consumer Reports, AmazonReviews, ePionions and other similar sites for those seeking quality and comparison information about a product or products. Recently, additional services designed to help users navigate and make sense of the amount of review information available on the web have emerged. Such sites include review aggregation and comparison sites such as Wize, Reevo and ShoppingPath, and social commerce sites that help navigate products such as Kaboodle, Bluedot and MyPickList. However, review and aggregation sites do not provide a ready resource for finding deeper information; review sites tend to provide static information about a product. For businesses conducting consumer research about their brands and products, these types of sources are limited.

For consumers seeking to make educated and informed decisions, however, it may not be enough to know that a product is highly rated, that one particular viewer or set of viewers likes the product, or what the product's standard features are. The consumer typically seeks or desires additional information, such as how well the product matches his/her individual requirements and needs. For example, a user may want to know whether a product is right for his/her application, whether it will work in the way it has been advertised, whether there is a better alternative, and perhaps most importantly, what the user doesn't know that they should know or ask about. Basically, a consumer seeks real world user feedback not fully available on static review sites or aggregation sites.

Web-based conversations (e.g., discussion boards, discussion forums, user groups and communities, etc) typically provide a wealth of such information to users that is not typically available from static review sites. Conversation sites provide information relevant to user groups as well as access to the expert and non-expert users in that group or community. However, it can be a cumbersome task to search and find such information, especially with the numerous disparate vendor sites and conversation sites available over the web. For a consumer, it can be quite a cumbersome and inefficient process to seek and obtain the desired product information and particularly quality of information particular to that individual user's need and requirements. For a corporate marketing department finding, aggregating and applying metrics to these conversations is laborious and difficult.

Therefore it is desirable to provide systems and methods that overcome the above and other problems. In particular, it is desirable to provide systems and methods that efficiently connect users with relevant information they seek from vendor sites and social networking sites.

### BRIEF SUMMARY OF THE INVENTION

The present invention provides search systems and methods for connecting users with relevant information about products or services in which they are interested. Relevant information provided to the users includes links to web pages where the product or service is available and links to discussion groups or other social networking communities where the product or service is being discussed and reporting on the frequency of specific brand and product discussions along with sentiment attributes. Embodiments of the present invention advantageously provide an efficient way to provide or connect consumers with relevant information and web-based conversations about products or services in which they are interested, without the consumer having to actively search multiple disparate websites in the hopes of finding relevant information and conversations. Once connected, users are able to dig deeper for additional information, such as by reviewing and/or joining a conversation or accessing additional sites presented by the system. Business users receive reporting and metrics quantifying the conversations about their brands, products and competitors.

According to one aspect of the present invention, a method is provided for creating a product information page including information from vendor sites and social network sites. The method typically includes performing a first search of a product database responsive to a search request received from a user system, the search request including one or more keywords, the product database including a table with entries for a plurality of pre-defined searchable products and one or more tags associated with each product, wherein the first search identifies a first product and one or more tags associated with the first product. The method also typically includes performing a second search of a vendor database using the one or more tags identified by the first search, performing a third search of a social network database using the one or more tags identified by the first search, and creating a product information page for the first product using results from the second and third searches.

According to another aspect of the present invention, a database system is provided that provides users with product information pages including information from vendor sites and social network sites. The system typically includes a product database including a table with entries for a plurality of pre-defined searchable products and one or more tags associated with each product. The system also typically includes a vendor database populated with entries from multiple vendor sites based on the tags associated with the products in the product database, and a discussion database populated with entries from multiple social network sites based on the tags associated with the products in the product database. The system further typically includes a processor (or processors) configured to implement logic for performing a first keyword search of the product database responsive to a search request received from a user system, the search request including one or more keywords, wherein the first search identifies a first product and one or more tags associated with the first product. The processor further typically implements logic for performing a second search of a vendor database using the one or more tags identified by the first search, and for performing a third search of a social network database using the one or more tags identified by the first search. The processor additionally typically implements logic for creating a product information page for the first product using results from the second and third searches. Data for the product page is typically sent to the requesting user over a network connection.

According to another aspect of the present invention, a database system is provided that provides users with reporting on the frequency and content of conversations. The system typically includes a product database including a table with entries for a plurality of pre-defined searchable products and one or more tags associated with each product. The system also typically includes a discussion database populated with entries from multiple social network sites based on the tags associated with the products in the product database. The system further typically includes a processor (or processors) configured to implement logic for performing a first keyword search of the product database responsive to a search request received from a user system, the search request including one or more keywords, wherein the first search identifies a first product and one or more tags associated with the first product. The processor further typically implements logic for performing a second search of a social network database using the one or more tags identified by the first search. The processor additionally typically implements logic for creating a reporting page for the first product using results from the second search. Data for the reporting page is typically sent to the requesting user over a network connection.

According to yet another aspect, a method of creating a reporting page including information from social network sites is provided. The method typically includes performing a first search of a product database responsive to a search request received from a user system, the search request including one or more keywords, the product database including a table with entries for a plurality of pre-defined searchable products and one or more tags associated with each product, wherein the first search identifies a first product and one or more tags associated with the first product. The method also typically includes performing a second search of a social network database using the one or more tags identified by the first search, wherein the second search produces search data, analyzing the search data to determine frequency information, and creating an information page for the first product using the frequency information.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an environment wherein a Product Discussion and Information database system might be used.

FIG. 2 illustrates elements of the Product Discussion and Information database system of FIG. 1 and various interconnections in more detail.

FIG. 3a illustrates a product database and FIG. 3b illustrates a search process initiated by a user according to one embodiment.

FIG. 4 illustrates a methodology for creating a product page according to one embodiment.

FIG. 5 illustrates an example of a product page created by PDIS 16 in response to a user search request.

FIG. 6 illustrates an example of a reporting page created by PDIS 16 in response to a user search request.

FIG. 7 illustrates an example of a reporting page.

### DETAILED DESCRIPTION

The present invention provides systems and methods for connecting users with information and discussion groups pertinent to a product or products of interest. In one embodiment, a Product Discussion and Information System is provided that, responsive to a user inquiry for information about a product or service, provides the user with relevant information about the product or service and links to discussion groups or other social networking sites where information about the product is being discussed or has been discussed along with links to vendor sites where the product or service may be available for purchase. In another embodiment, a Product Discussion and Information System is provided that, responsive to a user inquiry for information about a product or service, provides the user with relevant reporting information regarding discussion frequency and content as well as links to discussion groups or other social networking sites where information about the product is being discussed or has been discussed.

### System Overview

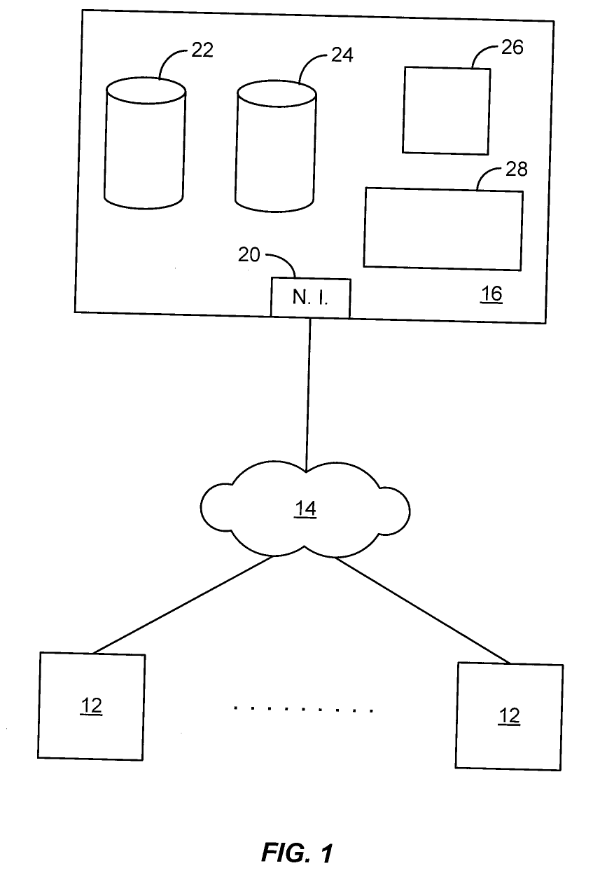

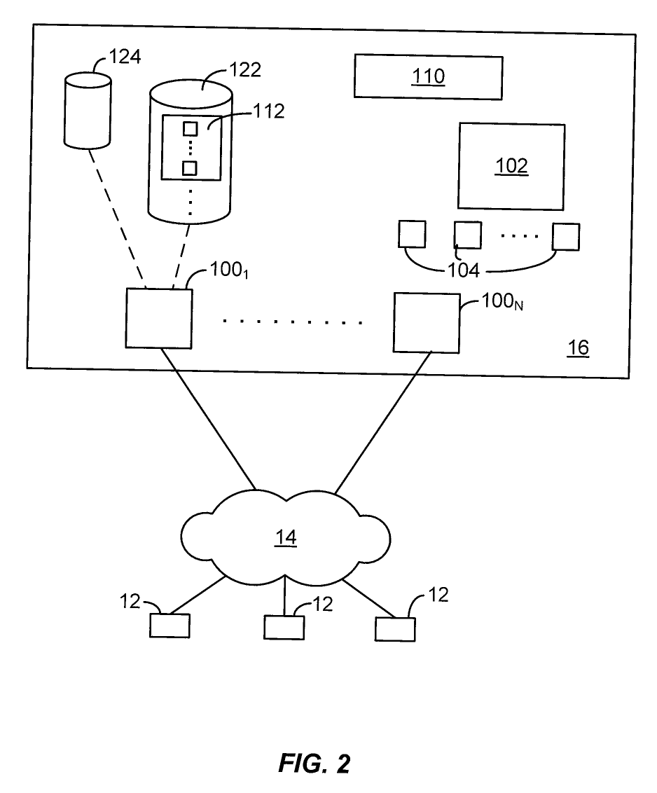

FIG. 1 illustrates an example of a Product Discussion and Information database system 16 according to one embodiment. As illustrated in FIG. 1 (and in more detail in FIG. 2), any user systems 12 might interact via a network 14 with a Product Discussion and Information database system (PDIS) 16. Network 14 can be a LAN (local area network), WAN (wide area network), wireless network, point-to-point network, star network, token ring network, hub network, or other configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that other networks can be used instead of the Internet, such as an intranet, an extranet, a virtual private network (VPN), a non-TCP/IP based network, any LAN or WAN or the like.

User systems 12 might communicate with PDIS 16 using TCP/IP and, at a higher network level, use other common Internet protocols to communicate, such as HTTP, FTP, AFS, WAP, etc. As an example, where HTTP is used, user system 12 might include an HTTP client commonly referred to as a “browser” for sending and receiving HTTP messages to and from an HTTP server at PDIS 16. Such HTTP server might be implemented as the sole network interface between PDIS 16 and network 14, but other techniques might be used as well or instead. In some implementations, the interface 20 between PDIS 16 and network 14 includes load sharing functionality, such as round-robin HTTP request distributors to balance loads and distribute incoming HTTP requests evenly over a plurality of servers. Preferably, each of the plurality of servers has access to the PDIS's data.

In one aspect, PDIS 16 can include application servers configured to 1) implement and execute web-crawling or spidering applications configured to search and retrieve data from various web sites on the Internet (e.g., over network 14 or other network interconnect medium) using specific search terms or tags, 2) provide related data, code, forms, web pages and other information to and from user systems 12 and/or 3) to store to, and retrieve from, a database system related data, objects and web page content.

One arrangement for elements of PDIS 16 is shown in FIG. 1, including a network interface 20, storage 22 for search data (e.g., product data, discussion site data and vendor site data), storage 24 for system data accessible to PDIS 16, program code 26 for implementing various functions of PDIS 16, and a process space 28 for executing PDIS system processes. Additional processes that may execute on PDIS 16 include database indexing processes and web crawling processes.

Several elements in the system shown in FIG. 1 include conventional, well-known elements that need not be explained in detail here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and data available to it from PDIS 16 over network 14. Each user system 12 also typically includes one or more user interface devices, such as a keyboard, a mouse, touch screen, pen or the like, for interacting with a graphical user interface (GUI) provided by the browser on a display (e.g., monitor screen, LCD display, etc.) in conjunction with pages, forms, data and other information provided by PDIS 16 or other systems or servers. For example, the user interface device can be used to access data stored or hosted by PDIS 16, and to perform searches on stored data, and otherwise allow a user to interact with various GUI pages that may be presented to the user.

According to one embodiment, each user system 12 and all of its components are operator configurable using applications, such as a browser, including computer code run using a central processing unit such as an Intel Pentium processor or the like. Similarly, PDIS 16 (and additional instances, where more than one PDIS is present) and all of its components might be operator configurable using application(s) including computer code run using a central processing unit such as an Intel Pentium processor or the like, or multiple processor units. Computer code for operating and configuring PDIS 16 to intercommunicate and to process web pages, applications and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, XML, any other markup language, Java, JavaScript, ActiveX, any other scripting language such as VBScript, and many other programming languages as are well known.

According to one embodiment, a PDIS 16 is configured to provide web pages, forms, data and media content to user (client) systems 12 to support the access by user systems 12 of PDIS 16. In one aspect, the system shown in FIG. 1 implements an open communication system where any user can access PDIS 16 using a known URL or other address information. In another aspect, the system shown in FIG. 1 implements a closed communication system where a user must register or log in to a host site prior to accessing information available from PDIS 16.

If more than one PDIS is used, they may be located in close proximity to one another (e.g., in a server farm located in a single building or campus), or they may be distributed at locations remote from one another (e.g., one or more servers located in city A and one or more servers located in city B). As used herein, each PDIS could include one or more logically and/or physically connected servers distributed locally or remotely across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 2 illustrates elements of PDIS 16 and various interconnections in more detail. In this example, the network interface is implemented as one or more HTTP application servers 100. Also shown is system process space 102 including individual process spaces 104, a system database 124, product information database(s) 122 and a database indexing process space 110. Product information database 122 might be divided into individual storage areas 112, which can be either a physical arrangement or a logical arrangement. Each storage area 112 may include one or more tables, objects or other data structures. For example, product information database 122 might include 1) a product information database, 2) a vendor information database and 3) a web discussion database as will be described in more detail below, where each database may be physically separate and/or logically separate from the other databases.

It should also be understood that each application server 100 may be communicably coupled to database systems, e.g., system database 106 and product information database(s) 122, via a different network connection. For example, one server 1001 might be coupled via the Internet 14, another server 100_{N-1} might be coupled via a direct network link, and another server 100_{N} might be coupled by yet a different network connection. Transfer Control Protocol and Internet Protocol (TCP/IP) are preferred protocols for communicating between servers 100 and the database system, however, it will be apparent to one skilled in the art that other transport protocols may be used to optimize the system depending on the network interconnect used.

In preferred aspects, each application server 100 is configured to handle requests for any user. Because it is desirable to be able to add and remove application servers from the server pool at any time for any reason, there is preferably no server affinity for a user to a specific application server 100. In one embodiment, therefore, an interface system implementing a load balancing function is communicably coupled between the servers 100 and the user systems 12 to distribute requests to the servers 100. In one aspect, the load balancer uses a least connections algorithm to route user requests to the servers 100. Other examples of load balancing algorithms, such as round robin and observed response time, also can be used. For example, in certain aspects, three consecutive requests from the same user could hit three different servers 100, and three requests from different users could hit the same server 100.

In certain aspects, client systems 12 communicate with application servers 100 to request data from PDIS 16 that may require one or more queries to database system 124 and/or database system 122. PDIS 16 (e.g., an application server 100 in PDIS 16) generates automatically one or more SQL statements (the SQL query) designed to access the desired information. Database system 122 may generate query plans to access the requested data from the database.

Each database can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a product database may include a table that includes fields for information such as a product description, product type, manufacturer, model, links to image(s), etc. Another table might include vendor information for products such as price and links to various vendor sites that sell or advertise the products. Another table might include web discussion information for products such as links to discussion sites or other social network sites where a product or product type has been discussed. It should be understood that “object” may also be used interchangeably herein with “table”.

### Product/Service Search

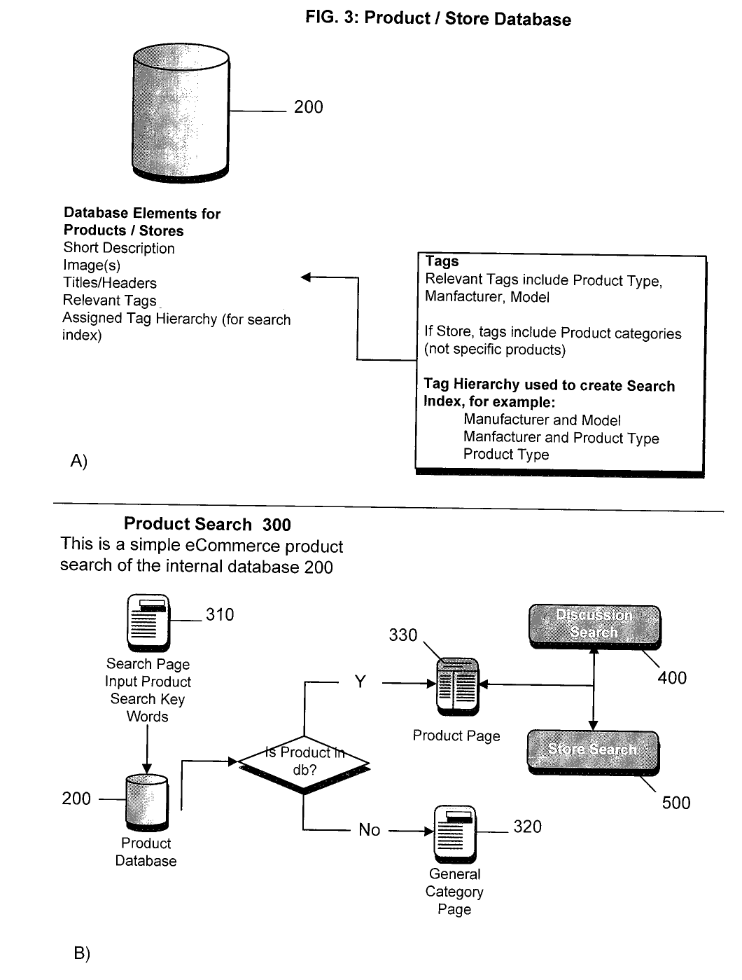

FIG. 3a illustrates a product database 200 and FIG. 3b illustrates a search process 300 initiated by a user according to one embodiment. Database 200 may be a stand alone database or it may be integrated with or coupled with another database physically or logically. For example, database 200 (and PDIS 16) may be separately accessible as its own website, or PDIS 16 and database 200 may be accessible only through another website, e.g., a website requiring user login access or user registration.

Database 200, in one embodiment, includes data for various products and services that a user may search using PDIS 16. In one embodiment, product database 200 is populated with data for specific products (and services) and/or product types/categories. In one aspect, data is manually input into database 200, however, automatic population in whole or in part may be performed. For example, in one aspect, a system administrator manually defines the products and services that are searchable in product database 200. For each product or product category, the administrator enters information such as a product name, a short description and other relevant information including, for example, images. In one aspect, the administrator also defines tags (keywords) and a tag hierarchy to be associated with the product entry. These tags and tag hierarchy are later used to perform secondary searches, e.g., searches of the store database 540 and the discussion database 440, to retrieve vendor and discussion site metadata for creating a product GUI page to present to the user. The tag hierarchy is used to create a search index for each database such that results returned from these databases are ranked in a relevancy order based on the tag hierarchy. The information entered for each product is stored to one or more data structures, such as a table, in database 200. In certain aspects, users may submit tags for inclusion in product database 200. The user-submitted tags are added to the database either automatically, or by an administrator (e.g., after a review) either manually or automatically.

Examples of relevant tags (keywords) might include product type, manufacturer and model. A tag might also include product categories. One example of a tag hierarchy for creating a search index would be:

Manufacturer and Model

Manufacturer and Product Type

Product Type

Upon accessing or logging into PDIS 16 or a site allowing access to PDIS 16, a user may access a Product Search page 310, e.g., by selecting a search button or icon. Alternatively, the user may be presented with Product Search page 310 upon accessing PDIS 16. In certain aspects, Product Search page 310 includes fields for entering and/or selecting one or more search terms as is well known. The user submits the search terms to PDIS 16 for processing, e.g., by entering and/or selecting terms and then selecting “search” or pressing “enter”. The search terms are sent back to PDIS 16, which searches product database 200 (using the entered search terms as keywords for searching the product database 200) to determine whether one or more matching products or services are included in database 200. If it is determined that there are no matching products or services in database 200, the system returns a general category page 320 to the user. General category page 320 may include results of a Google Search or other search engine, or it may include a page of related products that are similar to those initially searched.

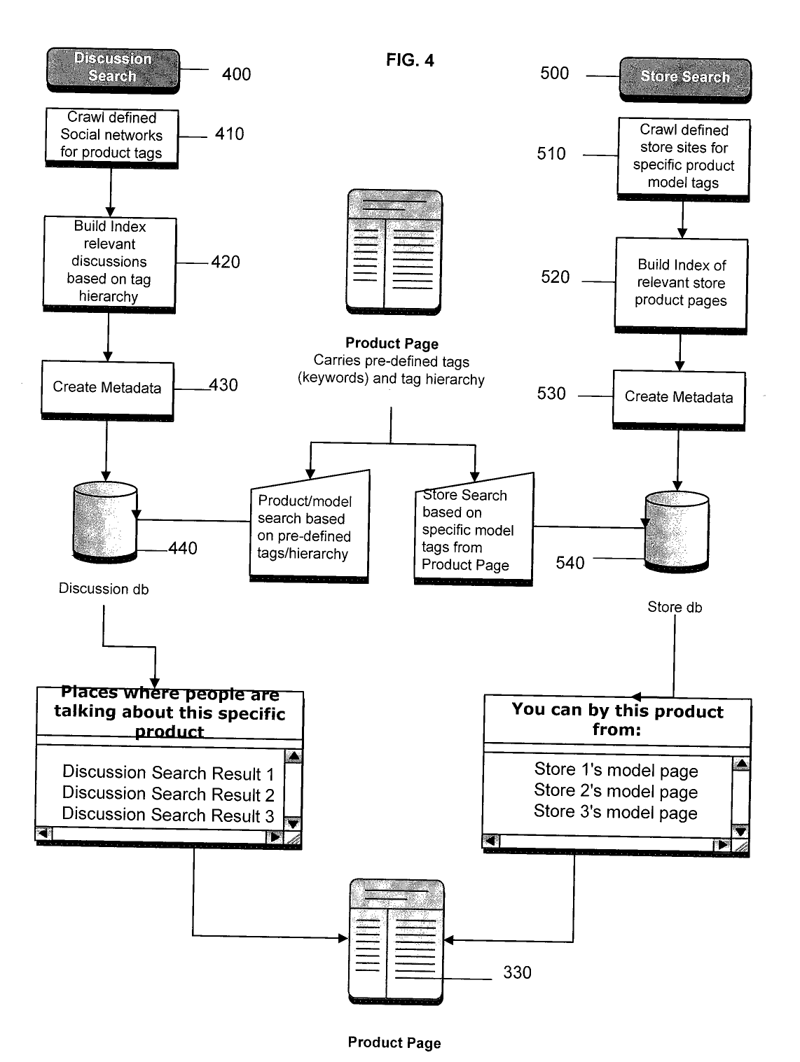

If it is determined that one or more matching products or services are included in database 200, a product page 330 is created and presented to the user. In certain aspects, the product page 330 includes vendor information such as links to one or more vendor sites that are advertising or selling the product and discussion information such as links to one or more social network sites where the product has been discussed. Other information such as portions of discussion threads may be presented as part of the product page. For example, portions of discussion threads may be presented with product tags highlighted. Vendor information is obtained from the store database 540 and discussion information is obtained from the discussion database 440 as will be discussed with reference to FIG. 4. The tags/keywords associated with the product searched are loaded from database 200 into a search engine and searches of both the discussion database 440 and store database 540 are conducted using the loaded tags as search terms into these databases. The search results from the store database 540 and discussion database 440 are used to create product page 330.

FIG. 4 illustrates a methodology for creating a product page 330 according to one embodiment. FIG. 4 also illustrates a process of populating a discussion database 440 with information from various social networking sites and populating a vendor/store database 540 with information retrieved from various vendor sites.

As shown in FIG. 4, a discussion search process 400 and a store search process 500 are executed, either together or separately. The search processes are, in certain aspects, run at times that would minimize impact on system resources. For example, the search processes may be run at time periods when there may low traffic such as very early in the morning or late at night. The discussion search process 400 includes a crawling or spidering process (e.g., Google Search Appliance or Lucene or Nutch, which is a configuration of Lucene including a built-in web-crawler) that searches various social network sites on the Internet and retrieves information using defined tags for each specific product. In certain aspects, the social network sites to be searched are pre-defined, e.g., by a system administrator. Examples of social network sites include discussion groups, review sites, discussion forums, or any other sites where discussion and review information may be obtained for the services and products.

In one embodiment, for each product included in product database 200, discussion search process 400 receives the tags from product database 200 that are associated with that product or service. These tags are used to search or crawl the defined social networking sites to obtain relevant information in step 410. Relevant information includes links to the site, links to specific discussion threads, portions of the discussion threads that include tags, etc. In step 420, an index is built and for each product, the relevant information obtained from the searched sites is indexed based on the (previously assigned) tags and tag hierarchy from product database 200. In step 430, metadata is created and stored in discussion database 440 for later retrieval, e.g., to create a product page 330 in response to a product search by a user. For example, when a user initiates a product search and the product search of database 200 indicates that the product is defined in database 200, one or more of the tags associated with that product entry in database 200 are loaded into a search engine, e.g., Lucene. The tags are used to search against the index for discussion database 440 that was previously created in step 420. The search results are returned for inclusion in product page 330. For example, in one aspect, the returned metadata will be in an order based on the search algorithm's interpretation of the tag hierarchy associated with the product database entry returned by the original product search of database 200.

The store search process 500 proceeds similar to the discussion search process 400. In one embodiment, for each product included in product database 200, store search process 500 begins, predefined tags for the product are loaded from database 200 and relevant information is obtained from defined vendor sites using the defined tags as search terms in step 510. Relevant information includes links to the site, links to specific product information, portions of product information (e.g., text) that include tags, etc. In one aspect, a vendor site provides relevant information to PDIS 16, e.g., in the form of an XML feed or other delivery mechanism. In step 520, retrieved (and/or vendor-provided) relevant information is indexed based on the predefined tags and/or tag hierarchy from product database 200. In step 530, metadata is created and stored in store database 540 for later retrieval, e.g., to create a product page 330 in response to a product search by a user. For example, when a product search of database 200 indicates that the product is defined in database 200, one or more of the tags associated with the product entry in database 200 are loaded into a search engine, e.g., Nutch/Lucene (http://lucene.apache.org/nutch/). The tags are used to search against the index for store database 540 that was created in step 520. The search results are returned for inclusion in product page 330. For example, in one aspect, the returned metadata will be in an order as determined by the tag hierarchy associated with the product database entry returned by the original product search of database 200.

It should be appreciated that discussion search process 400 may execute for all products in product database 200 at the same time or at different times. For discussion forums and other sites that timestamp entries, in certain aspects, it is only necessary to identify new or modified entries such that only the deltas/changes relative to the last search are updates into the database and indexed. In certain aspects, as mentioned above, the processes execute daily (typically at night to limit resource consumption) or at some other frequency. As discussion threads are added and vendor sites change, these changes and additions are included in the index in near real-time as determined by the frequency of crawling. In this manner, a user will be provided with useful, up-to-date vendor and discussion information regarding the product or service in which they are interested.

In one embodiment, PDIS 16 allows a user to refine a search after search results have been displayed. For example, in one aspect, a user is provided with a search refine toolbox which may include icons or entry fields for selecting additional search terms and functionality. For example, the user may be allowed to refine the search based on time (e.g., for discussion group information—display everything occurring within a defined time period) or keywords. The user may also be allowed to perform a comparison search of the searched product. For example, the user may be able to select a second product and search the corpus of results for any information comparing the products (or which discusses the two products). In one aspect a refined search request will search the corpus of results returned by the initial search.

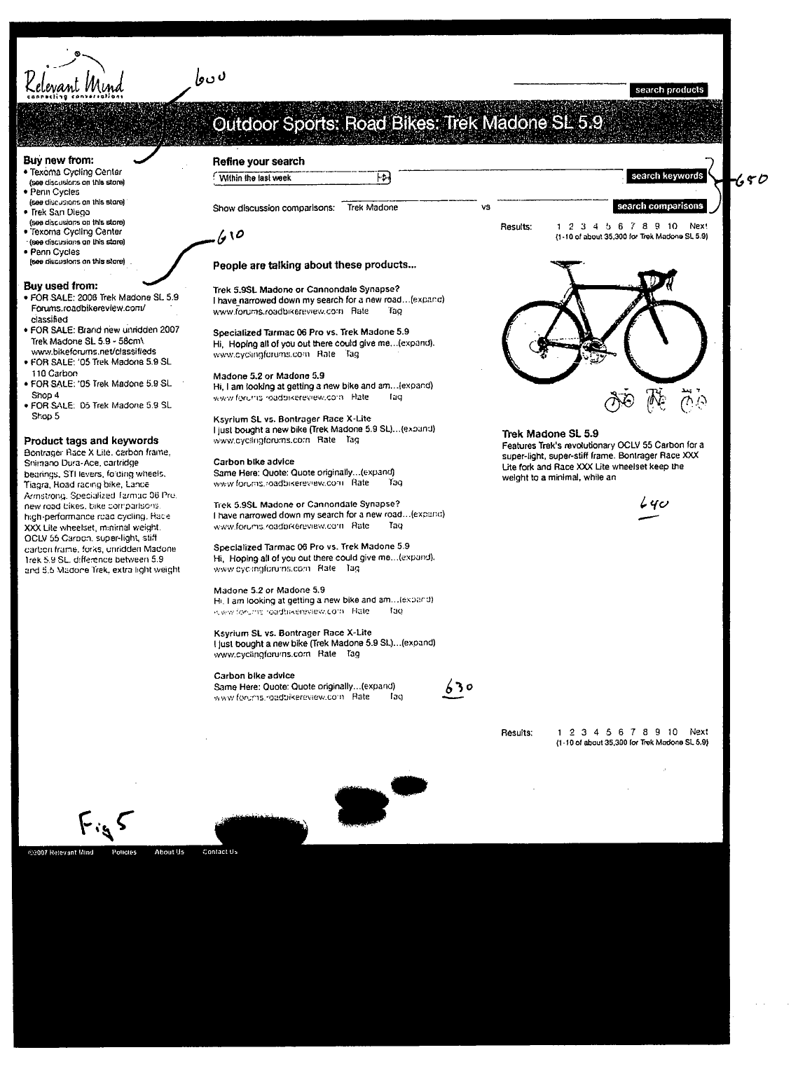

FIG. 5 illustrates an example of a product GUI page 600 created by PDIS 16 in response to a user search request. As shown, product page 600 includes vendor information panes 600, 610, and discussion information pane 630. Panes 600, 610 include links to vendor sites and other relevant information retrieved from store/vendor database 440. Discussion information pane 630 includes links to discussions and other relevant information retrieved from discussion database 440. In one aspect, information from product database 200 is displayed in pane 640. Such information may include, for example, and as shown, a product image and other information. From this page, a user may dig down deeper to obtain more detailed information. For example, the user may select a displayed vendor link to access additional information from a vendor, the user may select a displayed discussion link, e.g., to join in a conversation, or the user may further refine the search using refine search toolbox 650.

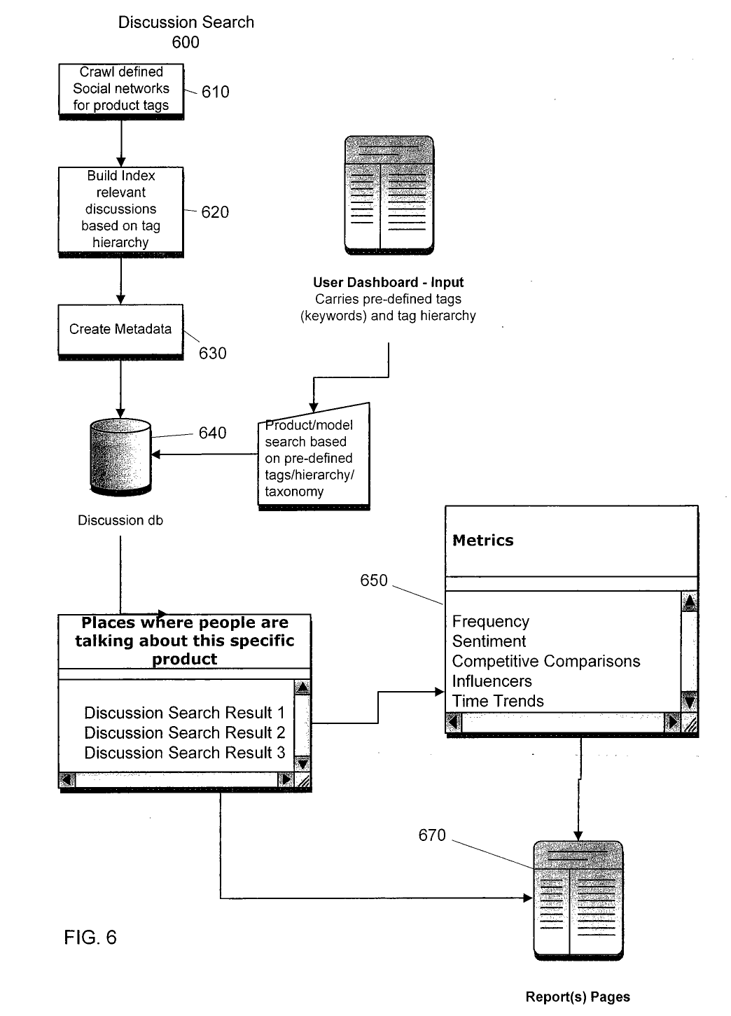

FIG. 6 illustrates a methodology for creating a reporting page 670 according to one embodiment. As shown in FIG. 4, a discussion search process 600 is executed similar to search process 400. The search process is, in certain aspects, run at times that would minimize impact on system resources. For example, the search process may be run at time periods when there may low traffic such as very early in the morning or late at night. The discussion search process 600 includes a crawling or spidering process (e.g., Google Search Appliance or Lucene or Nutch, which is a configuration of Lucene including a built-in web-crawler) that searches various social network sites on the Internet and retrieves information using defined tags for each specific product. In certain aspects, the social network sites to be searched are pre-defined, e.g., by a system administrator. Examples of social network sites include discussion groups, review sites, discussion forums, or any other sites where discussion and review information may be obtained for the services and products.

In one embodiment, for each product included in product database 200, discussion search process 600 receives the tags from product database 200 that are associated with that product or service. These tags are used to search or crawl the defined social networking sites to obtain relevant information in step 610. Relevant information includes links to the site, links to specific discussion threads, portions of the discussion threads that include tags, etc. In step 620, an index is built and for each product, the relevant information obtained from the searched sites is indexed based on the (previously assigned) tags and tag hierarchy from product database 200. In step 630, metadata is created and stored in discussion database 640 for later retrieval, e.g., to create a report page 670 in response to a product reporting search by a user. For example, when a user initiates a product reporting search and the product search of database 200 indicates that the product is defined in database 200, one or more of the tags associated with that product entry in database 200 are loaded into a search engine, e.g., Lucene. The tags are used to search against the index for discussion database 640 that was previously created in step 620. The search results are returned for inclusion in product page 670. For example, in one aspect, the returned metadata is further processed in step 650 to determine frequency information and other metrics of interest to the user. For example, in one aspect, the returned search results are analyzed to determine frequency and/or other information and a report page 670 including this information is generated for presentation to the user.

According to one aspect, execution of report generating involves three layers, the search layer, the processing logic layer and the presentation layer. The search layer is responsible for crawling target user communities, indexing the content and creating and storing the metadata as shown in steps 610 through 630, for example. The presentation layer produces a graphical representation of the data output from the processing logic layer, e.g., in the form of a report page 670, allowing users to view, manipulate and/or export the data. The processing logic layer implements various business logic rules to analyze the data and produce metrics of interest. The logic layer receives specific queries (e.g., product, time period, query type, etc.) from the user through the presentation layer. The logic layer in certain aspects, is built on a J2EE architecture, however, other architectures may be used. The logic layer pulls the product information from the internal database 200, including all associated equivalent search terms and attributes. Search terms might include multiple terms for the product that are “equivalent” in user community conversations. The logic layer then queries the search layer for a real-time parse of the search index. The search layer returns the raw data for the specified time period to the logic layer. The logic layer performs a series of calculations including, but not limited to, counts; statistical analysis; predictive analysis; relevancy ranking; comparisons; and other calculations. The logic layer sends this data to the presentation layer.

In certain aspects, the reporting capabilities of the logic layer allow a user to access reporting in many formats including graphs, charts and direct data transfer in formats such as xml, csv and Excel. Data content examples include the following:

Post Frequency—Brand, Product and Competitor Tracking

Users can track the number of times a specific brand, product or competitor (brand and/or product) is mentioned in user community posts. This frequency analysis includes trending over time so that users can match the impact on conversation volume of specific events, for example a public relations or marketing campaign. Users can compare trending over time for multiple brands, products and competitors.

Attribute Tracking—User Community Sentiment

Users can associate specific attributes with brands, products and competitors. These attributes can be characterized as positive or negative, and the resulting attribute frequency counts indicate user community sentiment around the search terms. Examples include both specific attributes (e.g., Expensive, Durable) and non-specific attributes (e.g., Excellent, Poor).

Influencers Analysis

Users can discover which specific members of the user communities “talk” about their brands, products or competitors. This data is ranked by both frequency and reach.

Conversation Aggregation

Users can directly access conversations in specific user communities about their brand, products or competitors, ranked by relevancy.

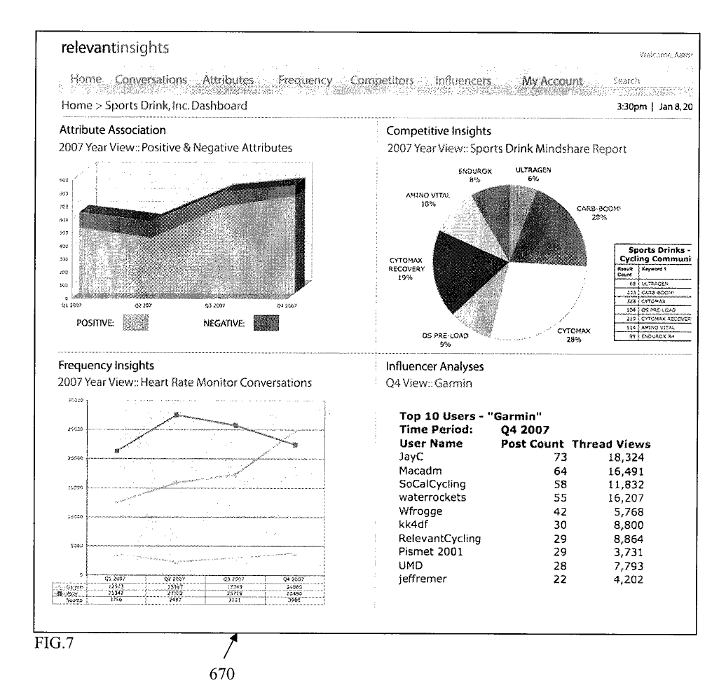

FIG. 7 illustrates an example of a report page 670 including data generated by the logic layer. As shown the report page 670 includes 4 different graphical representation formats, each displaying a different metric. The user may select one or more metrics, e.g., from a bar menu, or drop down menu displayed on a GUI page.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of creating a product information page including information from vendor sites and social network sites, the method comprising:
performing a first search of a product database responsive to a search request received from a user system, the search request including one or more keywords, said product database including a table with entries for a plurality of pre-defined searchable products and one or more tags associated with each product, wherein the first search identifies a first product and one or more tags associated with the first product;
performing a second search of a vendor database using the one or more tags identified by the first search;
performing a third search of a social network database using the one or more tags identified by the first search; and
creating a product information page for the first product using results from the second and third searches.

2. The method of claim 1, further comprising sending the product information page to said user system.

3. The method of claim 1, wherein said vendor database is populated with information for each of the pre-defined searchable products, wherein the information for each product is automatically retrieved from, or provided by, one or more vendor sites using the one or more tags associated with that product.

4. The method of claim 3, wherein the one or more vendor sites are pre-defined for each product.

5. The method of claim 1, wherein said social network database is populated with information for each of the pre-defined searchable products, wherein the information for each product is automatically retrieved from one or more social network sites using the one or more tags associated with that product.

6. The method of claim 5, wherein the one or more social network sites are pre-defined for each product.

7. The method of claim 5, wherein the social network sites includes a site selected from the group consisting of a web discussion board, a web forum site and a user group.

8. The method of claim 1, wherein performing a second search includes searching an index for the vendor database using the one or more tags identified by the first search.

9. The method of claim 8, wherein the index is created by crawling one or more pre-defined vendor sites using the tags associated with all products in the product database.

10. The method of claim 8, wherein the index is updated periodically.

11. The method of claim 1, wherein performing a third search includes searching an index for the social network database using the one or more tags identified by the first search.

12. The method of claim 11, wherein the index is created by crawling one or more pre-defined social network sites using the tags associated with all products in the product database.

13. The method of claim 1, wherein the tags in the product database have an assigned tag hierarchy.

14. The method of claim 1, wherein, when displayed on a user system, the product page includes one or more links to vendor web sites and one or more links to social network sites.

15. A database system for providing users with product information pages including information from vendor sites and social network sites, the system comprising:
a product database including a table with entries for a plurality of pre-defined searchable products and one or more tags associated with each product;
a vendor database populated with entries from multiple vendor sites based on the tags associated with the products in the product database;
a discussion database populated with entries from multiple social network sites based on the tags associated with the products in the product database;
a processor configured to implement logic for:
i) performing a first keyword search of the product database responsive to a search request received from a user system, the search request including one or more keywords, wherein the first search identifies a first product and one or more tags associated with the first product;
ii) performing a second search of a vendor database using the one or more tags identified by the first search;
iii) performing a third search of a social network database using the one or more tags identified by the first search; and
iv) creating a product information page for the first product using results from the second and third searches.

16. The system of claim 15, wherein the vendor and discussion databases are indexed.

17. The system of claim 15, wherein the product, vendor and discussion databases are physically separate or logically separate databases.

18. A method of creating a reporting page including information from social network sites, the method comprising:
performing a first search of a product database responsive to a search request received from a user system, the search request including one or more keywords, said product database including a table with entries for a plurality of pre-defined searchable products and one or more tags associated with each product, wherein the first search identifies a first product and one or more tags associated with the first product;
performing a second search of a social network database using the one or more tags identified by the first search, wherein the second search produces search data;
analyzing the search data to determine frequency information; and
creating an information page for the first product using the frequency information.

19. The method of claim 18, further comprising sending the information page to said user system.

20. The method of claim 18, wherein, when displayed on a user system, the information page includes one or more links to social network sites and relevant metrics on the frequency and/or content of conversations relating to the product.

21. The method of claim 18, wherein said social network database is populated with information for each of the pre-defined searchable products, wherein the information for each product is automatically retrieved from one or more social network sites using the one or more tags associated with that product.

22. The method of claim 21, wherein the one or more social network sites are pre-defined for each product.

23. The method of claim 21, wherein the social network sites includes a site selected from the group consisting of a web forum site and a user group.

24. The method of claim 18, wherein performing a second search includes searching an index for the social network database using the one or more tags identified by the first search.

25. The method of claim 24, wherein the index is created by crawling one or more pre-defined social network sites using the tags associated with all products in the product database.

26. The method of claim 18, wherein the tags in the product database have an assigned tag hierarchy.
